(19) United States
(12) Patent Application Publication
(10) Pub. No.: US 2026/0205377 A1
(43) Pub. Date: Jul. 16, 2026

(54) Artificial Intelligence Guided Cloud Integration Engine

(71) Applicant: Oracle International Corporation, Redwood Shores, CA (US)

(72) Inventors: Natalee Agassi, Blue Bell, PA (US); Nigel Timothy Meachen, Phoenixville, PA (US); Craig S. Robinson, Downingtown, PA (US); Susan Diane McKernan, Lansdale, PA (US)

(73) Assignee: Oracle International Corporation, Redwood Shores, CA (US)

(21) Appl. No.: 19/448,258

(22) Filed: Jan. 14, 2026

Related U.S. Application Data
(60) Provisional application No. 63/745,379, filed on Jan. 15, 2025.

(51) Int. Cl. H04L 41/16; H04L 41/0806; H04L 67/1095

(52) U.S. Cl. CPC H04L 41/16; H04L 41/0806; H04L 67/1095

(57) ABSTRACT

In some embodiments, a system receives, from a requester system, a request for a data integration process that exchanges data between the requester system and a target system and then obtains one or more attributes of the requester system and one or more attributes of the target system. Next, the system may generate a connectivity configuration based on the one or more attributes of the target system using an artificial intelligence (AI) model and generate a transformation configuration based on the one or more attributes of the requester system and the one or more attributes of the target system using the AI model. The system may then execute the data integration process using the connectivity configuration to establish a connection between the requester system and the target system and using the transformation configuration to perform a data transformation process on data transferred between the requester system and the target system.

### INCORPORATION BY REFERENCE

U.S. Provisional Patent Application 63/745,379, filed Jan. 15, 2025, is hereby incorporated by reference.

### TECHNICAL FIELD

The present disclosure relates to enabling data flow between different systems. In particular, the present disclosure relates to an integration engine that facilitates data flow between different systems.

### BACKGROUND

An integration engine is a software solution that acts as a central hub that connects computer systems and manages the flow of data between them. Integration engines are used in many industries, including healthcare, finance, and eCommerce, to improve productivity and streamline processes.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for facilitating data flow between different systems in accordance with one or more embodiments;

FIG. 3 illustrates a user interface displaying instances of execution of data integration processes between requester systems and target systems in accordance with one or more embodiments;

FIG. 4 illustrates a user interface displaying a connectivity configuration in accordance with one or more embodiments;

FIG. 5 illustrates a user interface displaying a transformation configuration in accordance with one or more embodiments;

FIG. 6 illustrates a machine learning (ML) engine in accordance with one or more embodiments;

FIG. 7 illustrates an example set of operations of an ML engine in accordance with one or more embodiments; and

FIG. 8 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. INTEGRATION SYSTEM ARCHITECTURE
3. FACILITATING DATA FLOW BETWEEN DIFFERENT SYSTEMS
4. EXAMPLE EMBODIMENTS
5. MACHINE LEARNING ARCHITECTURE
6. PRACTICAL APPLICATIONS, ADVANTAGES, AND IMPROVEMENTS
7. COMPUTER NETWORKS AND CLOUD NETWORKS
8. HARDWARE OVERVIEW
9. MISCELLANEOUS; EXTENSIONS

### 1. General Overview

Due to the variation in attributes of different systems, determining a configuration of parameters for a data integration process between different systems is complex. As a result, in addition to being time consuming, the process of determining the configuration of parameters is prone to error, thereby negatively affecting the data integration process and the computer systems involved. For example, incorrect or otherwise inadequate parameter configuration can result in data loss, inconsistency, and inefficient system performance.

One or more embodiments use an artificial intelligence (AI) model to determine a configuration of parameters for a data integration process between a requester system and a target system. The terms “requester” and “target” are used herein to help distinguish between a system that submits a request for a data integration process and a system that is the target of the request. For example, as disclosed herein, a requester system may submit, to a computer system, a request for a data integration process that transfers data between the requester system and a target system. The computer system may generate a configuration of parameters for the data integration process based on the attributes of the requester system and the target system using an AI model. The configuration of parameters may include a connectivity configuration of one or more connection parameters for establishing a connection between the requester system and the target system. The configuration of parameters may also include a transformation configuration of one or more transformation parameters for performing a data transformation process. The computer system may execute the data integration process using the configuration of parameters generated using the AI model. For example, the computer system may establish a connection between the requester system and the target system using the one or more connectivity parameters, and then transfer data between the requester system and the target system using the established connection. In transferring the data between the requester system and the target system, the computer system may perform the data transformation process on the transferred data using the one or more transformation parameters.

By using the AI model to generate the configuration parameters for the data integration process, the computer system of the present disclosure increases the efficiency of the configuration process for configuring the configuration parameters. For example, the computer system's generation of configuration parameters eliminates a user's need to navigate and search through large amounts of user interface elements in search of the optimal or otherwise appropriate configuration parameters, thereby improving the user interface experience for the data integration process. Furthermore, the computer system of the present disclosure ensures that the most appropriate configuration parameters for the data integration process are used. As a result, the ability of the computer system to successfully establish a connection between different systems, transfer data between the different systems, and transform the data transferred between the different systems is improved.

One or more embodiments described in this Specification and/or recited in the claims may not be included in this General Overview section.

### 2. Integration System Architecture

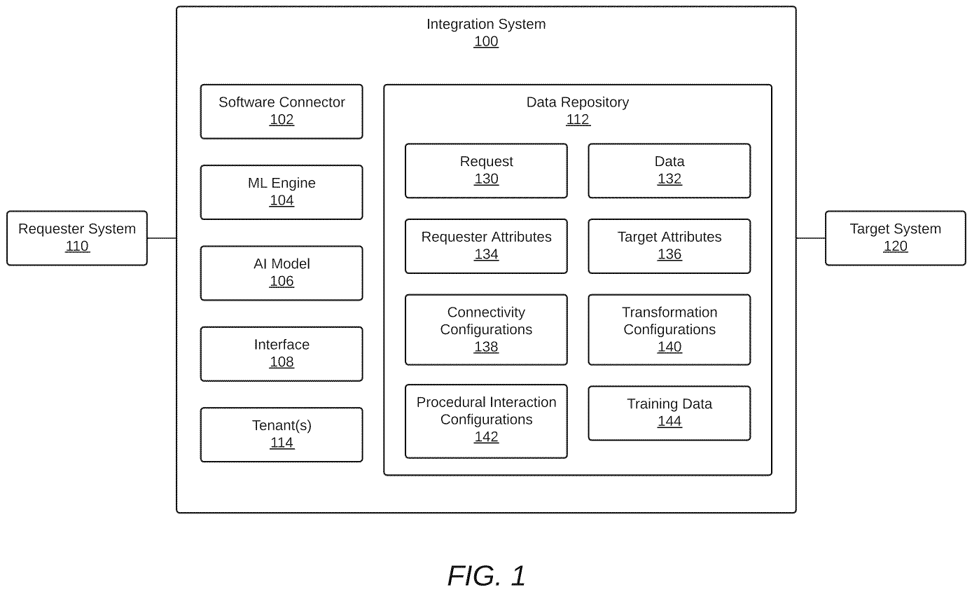

FIG. 1 illustrates an integration system 100 in accordance with one or more embodiments. In one or more embodiments, the integration system 100 includes an integration engine platform that allows users to connect and integrate various systems across on-premise and cloud environments. For example, a user may interact with the integration system 100, via a computing device of the user, to submit a request for the integration system 100 to connect and integrate a requester system 110 and a target system 120. The requester system 110 and the target system 120 may separately include a software application, a data source, a computer system, or any machine or computing component that may connect to another computing component to move data between the different computing components. For example, the requester system 110 may include a billing software application being used by a medical provider, and the target system 120 may include an automated medication dispensing machine (e.g., a computer-controlled machine that stores, dispenses, and tracks medications). Other types of systems that may be included in the requester system 110 or the target system 120 include, but are not limited to, patient monitoring devices (e.g., blood pressure monitors, glucometers, pulse oximeters), human resource software applications, and healthcare software applications used by doctors and other healthcare providers.

In one or more embodiments, the integration system 100 is configured to receive a request for a data integration process from the requester system 110. The data integration process is configured to transfer data between the requester system 110 and the target system 120. The transfer of data may be in either direction, from the target system 120 to the requester system 110 or from the requester system 110 to the target system 120. For example, the data integration process may be configured to extract data from the target system 120 to the requester system 110. The data integration process may also be configured to add data from the requester system 110 to the target system 120. Other types of data integration processes are also within the scope of the present disclosure.

As illustrated in FIG. 1, in some embodiments, integration system 100 includes a software connector 102, a machine learning (ML) engine 104, an artificial intelligence (AI) model 106, an interface 108, one or more tenants 114, and a data repository 112. The integration system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The components illustrated in FIG. 1 may communicate with one another via one or more computer networks. Furthermore, one or more components illustrated in FIG. 1 may be implemented as part of a cloud network. Additional embodiments and/or examples relating to computer networks are described below in Section 7, titled “Computer Networks and Cloud Networks.”

In one or more embodiments, the data repository 112 is any type of storage unit and/or device (e.g., a file system, database, collection of tables, or any other storage mechanism) for storing data. Further, the data repository 112 may include multiple different storage units and/or devices. The multiple different storage units and/or devices may or may not be of the same type or located at the same physical site. Further, a data repository 112 may be implemented or executed on the same computing system as the other components of integration system 100 (e.g., software connector 102, ML engine 104, and AI model 106). Additionally, or alternatively, a data repository 112 may be implemented or executed on a computing system separate from the other components of integration system 100. The data repository 112 may be communicatively coupled to one or more of the other components of integration system 100 via a direct connection or via a network. Furthermore, data sets illustrated within the data repository 112 may be implemented across any of components within integration system 100, in a decentralized and/or distributed manner. The data sets are illustrated within the data repository 112 for purposes of clarity and explanation.

In one or more embodiments, the data repository 112 stores one or more requests 130 for a data integration process that transfers data 132 between a requester system 110 and a target system 120. A request 130 may include details that specify key aspects of the data integration process being requested. For example, a request 130 may include one or more of an identification of a requester system 110, an identification of a target system 120, a type of the data 132 to be transferred, a frequency of the transfer being requested, a purpose of the requested transfer, a priority level of the transfer, or security, privacy, or compliance requirements for the requested transfer. The request 130 may also include a unique identifier for the request 130. Other configurations of the request 130 are also within the scope of the present disclosure.

In an embodiment, the data repository 112 also stores the data 132 that has been requested to be transferred in a requested data integration process and/or that has been transferred in a previously-requested and executed data integration process. The integration system 100 may receive the data 132 from the requester system 110 or from the target system 120. The data 132 may include different types of data. In one example, the data 132 includes raw data collected from one or more other systems, such as databases, files, software applications, sensors, logs, or API's. The data 132 may also include transformed data. In one example, the data 132 includes data that has been cleaned and transformed, such as source data that has gone through one or more of format conversion, deduplication, normalization, or enrichment with additional attributes. Other configurations of the data 132 are also within the scope of the present disclosure.

In some embodiments, the data repository 112 stores requester attributes 134 of one or more requester systems 110 and target attributes 136 of one or more target systems 120. The attributes 134 and 136 may include, but are not limited to, one or more of the following types of attributes: a type of system (e.g., a medication dispensing device, a billing software application), a vendor of the system (e.g., a manufacturer or provider of a device or software application), a product identifier of the system, a model number of the system, a version number of the system, or a data format used by the system. Other types of attributes are also within the scope of the present disclosure.

In one or more embodiments, the data repository 112 stores connectivity configurations 138. A connectivity configuration 138 includes one or more connection parameters for establishing a connection between the requester system 110 and the target system 120. The connection parameters of the connectivity configuration 138 may include one or more of a server identification, an Internet Protocol (IP) address, a port identification, a security certificate file, a user identification, a password, a connection type, or a connection protocol. Other types of connectivity parameters for the connectivity configuration 138 are also within the scope of the present disclosure.

In some embodiments, the data repository 112 stores transformation configurations 140. A transformation configuration 140 includes one or more transformation parameters for performing a data transformation process. In one example, the one or more transformation parameters include one or more data mapping parameters for mapping data between the requester system and the target system. A data mapping parameter includes a defined variable or rule used in a data mapping process that specifies the source fields in a source system from which data is to be transferred maps to the target fields in a target system to which data is to be transferred. In another example, the one or more transformation parameters include one or more data conversion parameters for converting data between a format of the requester system and a format of the target system. A data conversion parameter specifies how source data should be transformed into the required format, structure, or value set of the target system to which it is being transferred. As a result, a data conversion parameter controls the transformation logic applied to data elements as they are converted from a source system's representation to a target system's representation in a data integration process. Examples of data conversion parameters include, but are not limited to, parameters that specify format changes (e.g., date formats, number precision, text encoding), value translation (e.g., mapping “Y/N” to “true/false”), unit conversion (e.g., pounds to kilograms), or default or fallback values (e.g., when source data is missing or invalid).

In one or more embodiments, the data repository 112 stores procedural interaction configurations 142. A procedural interaction configuration 142 includes (a) a specific sequence of operations to be used in the execution of the data integration process or (b) a set of one or more rules that restricts user input for inclusion in the data to be transferred between the requester system 110 and the target system 120 in the data integration process to a subset of a set of values. One example of a procedural interaction configuration 142 includes a specific sequence of operations that includes (a) a first operation in which the requester system 110 transmits a first type of message to the target system 120, (b) a second operation (to be performed after the execution of the first operation) in which the target system 120 transmits a second type of message (different from the first type of message) to the requester system 110, and (c) a third operation (to be performed after the execution of the second operation) in which the requester system 110 transmits a third type of message (different from the first and second types of messages) to the target system 120. One example of a rule that restricts user input for inclusion in the data to be transferred in the data integration process is a rule that restricts a medical provider with a particular authorization level to send a request to a pharmacy for only a particular class of medications. Other types of procedural interaction configurations 142 are also within the scope of the present disclosure.

In some embodiments, the data repository 112 stores training data 144. The training data 144 includes one or more labeled or structured datasets configured to be used to build or tune the AI model 106. In an embodiment, the training data 144 includes the following: (a) historical connectivity configurations 138 that have been used in instances of execution of data integration processes between requester systems 110 and target systems 120; (b) historical transformation configurations 140 used in the instances of execution of the data integration processes; (c) historical attributes 136 of the target systems 120 corresponding to the historical connectivity configurations 138; and (d) historical attributes 136 of the requester systems 110 and the target systems 120 corresponding to the historical transformation configurations 140. Other configurations of the training data 144 are also within the scope of the present disclosure.

In one or more embodiments, the software connector 102 includes a software component that enables systems, such as the requester system 110 and the target system 120, to communicate and exchange data with one another. In an embodiment, the software connector 102 is configured to use the AI model 106 to generate results that represent a proposed model for a data integration process. The proposed model includes configurations of parameters and/or attributes that may be used in executing the requested data integration process. In one example, the proposed model includes a system and code system values, such as a medical coding system and medical coding system values, for use in the requested data integration process. Other types of configurations of the proposed model are also within the scope of the present disclosure.

In some embodiments, the software connector 102 is configured to generate a connectivity configuration 138 and a transformation configuration 140 for the requested data integration process using the AI model 106. The AI model 106 may be configured to generate the connectivity configuration 138 based on one or more attributes 136 of the target system 120. The AI model 106 may also be configured to generate the transformation configuration 140 based on a combination of one or more attributes 134 of the requester system 110 and one or more attributes 136 of the target system 120.

In an embodiment, connectivity configurations 138 and transformation configurations 140 include respective sets of predefined allowable values (e.g., one or more ranges of values for a particular parameter) from which a user can select for the requested data integration process. The sets of predefined allowable values may correspond to respective intents or contexts of the requested data integration process. The intent or context of the requested data integration process may be determined based on one or more requester attributes 134 of one or more requester systems 110, one or more target attributes 136 of one or more target systems 120, or a combination thereof. In generating the connectivity configuration 138 or the transformation configuration 140 for a requested data integration process, the AI model 106 may determine the intent or context of the requested data integration process based on one or more requester attributes 134 and one or more target attributes 136, and then determine a set of predefined allowable values for a particular configuration parameter. The set of predefined allowable values may be displayed to the user so that the user may select a particular value from the set of predefined allowable values for the particular configuration parameter. In some embodiments, the set of predefined allowable values includes a single value that is automatically set for the particular configuration parameter.

In some embodiments, connectivity configurations 138 and transformation configurations 140 include respective sets of intents or contexts from which the user may select for the requested data integration process. For example, the AI model 106 may determine, based on one or more requester attributes 134 and one or more target attributes 136, that the particular intention of the user in requesting the data integration process is one of three possible intentions. The three possible intentions may have respective sets of predefined allowable values for a particular parameter. The software connector 102 may display the three possible intentions to the user for selection, and, based on the user's selection of a particular intention, respective set of predefined allowable values corresponding to the selected particular intention may be displayed to the user for selection for use in the requested data integration process.

The software connector 102 may be configured to obtain the attributes 134 of the requester system 110 and the attributes 136 of the target system 120 directly from the requester system 110 and the target system 120, respectively. Additionally, or alternatively, the software connector 102 may obtain the attributes 134 of the requester system 110 and the attributes 136 of the target system 120 from the data repository 112. For example, the data repository 112 may store one or more requester attributes 134 of the requester system 110 and one or more target attributes 136 of the target system 120 for retrieval by the software connector 102 in generating the connectivity configuration 138 and the transformation configuration 140.

In one or more embodiments, the software connector 102 is also configured to execute the data integration process using the connectivity configuration 138 and the transformation configuration 140. For example, software connector 102 may be configured to establish a connection between the requester system 110 and the target system 120 using the connectivity parameters of the connectivity configuration 138 and to transfer data between the requester system 110 and the target system 120 using the established connection. In some embodiments, the software connector 102 is configured to perform, as part of the data integration process, a data transformation process on the transferred data using the transformation parameters of the transformation configuration 140. Data transformation may include a process of changing data from one format or structure to another, which may involve cleaning, manipulating, and converting data to meet specific requirements of the system to which it is being transferred in the data integration process. One type of data transformation process that may be performed as part of the data integration process is mapping data between the requester system 110 and the target system 120. Mapping includes defining how data fields from one location correspond to data fields in another location, essentially creating a link between the two locations to facilitate accurate data transfer. For example, the software connector 102 may use the transformation configuration 140 to link a data field of the requester system 110 to a data field of the target system 120. Another type of data transformation process that may be performed as part of the data integration process is converting data between a format of the requester system 110 and a format of the target system 120. Other types of data transformation processes are also within the scope of the present disclosure.

In some embodiments, the ML engine 104 is configured to generate the AI model 106 that is used by the software connector 102 to generate the connectivity configuration 138 and the transformation configuration 140. Furthermore, the ML engine 104 may be configured to generate a corresponding AI model 106 for multiple different use cases. For example, the ML engine 104 may generate a corresponding AI model 106 for a use case in which the requester system 110 is a billing system, and the target system 120 is an automated medication dispensing machine. The ML engine 104 may also generate another corresponding AI model 106 for a use case in which the requester system 110 is an electronic health record (EHR) system, and the target system 120 is a digital medical diagnostic device. Other use cases are within the scope of the present disclosure, and the ML engine 104 may generate corresponding AI models 106 for those other use cases as well.

In an embodiment, the ML engine 104 includes a Large Language Model (LLM). The LLM may use a deep neural network to generate outputs based on patterns learned from training data 144. The LLM may include an implementation of a transformer-based architecture. In contrast to recurrent neural networks that use recurrence as the main mechanism for capturing relationships between tokens in a sequence, transformer-based neural networks use self-attention as their mechanism for capturing relationships. Other implementations of the LLM are also within the scope of the present disclosure.

In one or more embodiments, the ML engine 104 is configured to use supervised learning to train an LLM to generate AI models 106. The ML engine 104 may train the LLM using training data 144 that includes historical data, such as (a) historical connectivity configurations 138 and transformation configurations 140 that have been used in instances of execution of data integration processes between requester systems 110 and target systems 120, and (b) historical requester attributes 134 of requester systems 110 and target attributes 136 of target systems 120 corresponding to the connectivity configurations 138 and transformation configurations 140 used in those instances. For example, for an instance of executing a data integration process between a particular requester system 110 and a particular target system 120, the training data may include a historical connectivity configuration 138 and a historical transformation configuration 140 that were used in the instance of execution of the data integration process, as well as the historical requester attributes 134 of the particular requester system 110 and the historical target attributes 136 of the particular target system 120.

The ML engine 104 may also be configured to generate corresponding classifications for the AI models 106 generated by the ML engine 104. The classifications may be specific to the particular use case for which they were generated, such as the historical requester attributes 134 of the requester system 110 and/or historical target attributes 136 of the target system 120 that were used to train the corresponding AI model 106. For example, one AI model 106 may be classified for use in situations in which the target system 120 is a medication dispensing device, whereas another AI model 106 may be classified for use in situations in which the requester system 110 is an EHR system and the target system 120 is a digital medical diagnostic device. Other types of classifications of the AI models 106 are also within the scope of the present disclosure. In some embodiments, the machine learning engine 104 uses an LLM to classify the AI models 106. However, other types of ML models may be used to classify the AI models 106 as well.

Additional embodiments and/or examples relating to the ML engine 104 and the AI model 106 are described below in Section 5, titled “Machine Learning Architecture.” The features and embodiments described in Section 5 may be used to implement the ML engine 104 and the AI model 106. The ML engine 104 and the AI model 106 may be implemented in other ways not described in Section 5 as well.

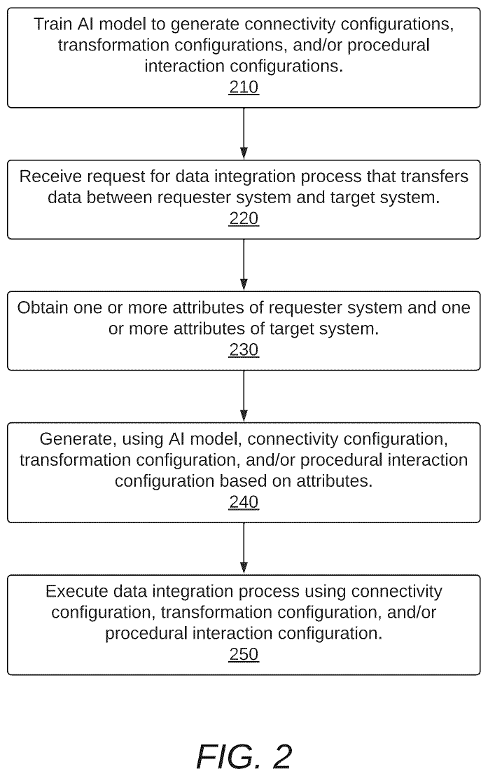

In one or more embodiments, the integration system 100 refers to hardware and/or software configured to perform operations described herein for facilitating data flow between different systems. Examples of operations for facilitating data flow between different systems are described below with reference to FIG. 2.

In an embodiment, the integration system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 108 refers to hardware and/or software configured to facilitate communications between a user and the integration system 100. Interface 108 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 108 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 108 is specified in one or more other languages, such as Java, C, or C++.

In some embodiments, the integration system 100 includes a multi-tenant platform hosted by a cloud service provider. The multi-tenant platform may include multiple tenants having corresponding target environments associated with them (e.g., a first target environment associated with a first tenant, a second target environment associated with a second tenant, etc.). The components of integration system 100 and their functions may be implemented by a service provided and managed by the cloud service provider.

In one or more embodiments, a tenant (such as tenant 114 is a corporation, organization, enterprise, or other entity that accesses a shared computing resource such as the other components of integration system 100 illustrated in FIG. 1. In an embodiment, tenants 114 are independent from each other. A business or operation of one tenant 114 is separate from a business or operation of another tenant 114.

### 3. Facilitating Data Flow Between Different Systems

FIG. 2 illustrates an example set of operations for facilitating data flow between different systems in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the integration system trains an AI model, using training data, to generate connectivity configurations and transformation configurations (Operation 210). The training data may include historical data, such as (a) historical configurations that have been used in instances of execution of data integration processes between requester systems and target systems, and (b) historical attributes of the requester systems and target systems corresponding to the configurations used in those instances. For example, for an instance of execution of a data integration process between a particular requester system and a particular target system, the training data may include a historical connectivity configuration and a historical transformation configuration that were used in the instance of execution of the data integration process, as well as the historical attributes of the particular requester system and the historical attributes of the particular target system. In some embodiments, the integration system trains different AI models for use in different use cases, such that a user may select a particular AI model based on a corresponding classification of the particular AI model.

In one or more embodiments, the integration system receives, from a requester system, a request for a data integration process that transfers data between the requester system and a target system (Operation 220). The integration system may receive the request via a user interface portal of an integration engine platform. For example, a user may access the user interface portal using a computing device and submit the request via the user interface portal. The request may specify the requester system, the target system, and the data integration process. The user may submit the user input via one or more user interface elements. In an embodiment the user input includes a natural language input submitted by the user as a prompt to generate a request for a data integration process.

In some embodiments, the integration system obtains one or more attributes of the requester system and one or more attributes of the target system (Operation 230). The attributes of a particular system, such as the requester system or the target system, may include one or more of the following types of attributes: a type of system (e.g., a medication dispensing device, a billing software application), a vendor of the system (e.g., a manufacturer or provider of a device or software application), a product identifier of the system, a model number of the system, a version number of the system, or a data format used by the system. Other types of attributes are also within the scope of the present disclosure.

The integration system may obtain the attributes of the requester system and the attributes of the target system directly from the requester system and the target system, respectively. For example, the integration system may communicate with the requester system and the target system to request the corresponding attributes from the requester system and the target system directly. Additionally, or alternatively, the system may obtain the attributes of the requester system and the attributes of the target system from the data repository. For example, the data repository may store one or more attributes of the requester system and one or more attributes of the target system. The integration system may retrieve, or otherwise obtain, the attributes of the requester system or the target system using the corresponding identification of the requester system or the target system to find the corresponding attributes stored in the data repository. Additionally, or alternatively, the integration system may obtain the attributes from the request for the data integration process. For example, the user may specify one or more attributes of the requester system or the target system in the request, and the system may extract the attributes from the request.

In an embodiment, the integration system generates a connectivity configuration and a transformation configuration using an AI model (Operation 240). The integration system may automatically select the AI model from a group of previously trained AI models based on a matching of a classification of the request for the data integration process and a classification of the AI model. For example, the integration system may automatically select a particular AI model based on the request for the data integration process and the particular AI model both having a classification of a data integration process between a target system that is a medication dispensing device and a requester system that is a billing software application. Alternatively, the system may display the group of AI models, along with their corresponding classification, on a computing device of a user, and the user may select one of the AI models for use in the generation of the connectivity configuration and the transformation configuration.

In some embodiments, the AI model generates the connectivity configuration based on the one or more attributes of the target system. The connectivity configuration may include one or more connection parameters for establishing a connection between the requester system and the target system. The one or more connection parameters of the connectivity configuration may include one or more of a server identification, an IP address, a port identification, a security certificate file, a user identification, a password, a connection type, or a connection protocol. Other types of connection parameters are also within the scope of the present disclosure. In generating the connectivity configuration, the AI model may generate a plurality of connectivity configurations that include the connectivity configuration. The integration system may then cause the plurality of connectivity configurations to be displayed, or otherwise presented, on a computing device, where a user of the computing device may select one of the plurality of connectivity configurations for use in the data integration process.

In one or more embodiments, the AI model also generates the transformation configuration based on a combination of the one or more attributes of the requester system and the one or more attributes of the target system. The transformation configuration may include one or more transformation parameters for performing a data transformation process. In some embodiments, the one or more transformation parameters of the transformation configuration include one or more data mapping parameters for mapping data between the requester system and the target system. For example, the one or more transformation parameters may include a specification that defines how one or more data fields from the target system correspond to one or more data fields in the requester system. Additionally, or alternatively, the one or more transformation parameters of the transformation configuration may include one or more data conversion parameters for converting data between a format of the requester system and a format of the target system. In generating the transformation configuration, the AI model may generate a plurality of transformation configurations that includes the transformation configuration. The integration system may then cause the plurality of transformation configurations to be displayed, or otherwise presented, on a computing device, where a user of the computing device may select one of the plurality of transformation configurations for use in the data integration process.

In an embodiment, the integration system also generates a procedural interaction configuration using the AI model. The procedural interaction configuration includes (a) a specific sequence of operations to be used in the execution of the data integration process or (b) a set of one or more rules that restricts user input for inclusion in the data to be transferred via the data integration process to only a subset of a set of values. One example of a procedural interaction configuration includes a specific sequence of operations that includes (a) a first operation in which the requester system transmits a first type of message to the target system, (b) a second operation (to be performed after the execution of the first operation) in which the target system transmits a second type of message (different from the first type of message) to the requester system, and (c) a third operation (to be performed after the execution of the second operation) in which the requester system transmits a third type of message (different from the first and second types of messages) to the target system. One example of a rule that restricts user input for inclusion in the data to be transferred in the data integration process is a rule that restricts a medical provider with a particular authorization level to send a request to a pharmacy for only a particular class of medications. Other types of procedural interaction configurations are also within the scope of the present disclosure.

In some embodiments, the integration system executes the data integration process using the connectivity configuration and the transformation configuration (Operation 250). For example, the integration system may execute the data integration process by establishing a connection between the requester system and the target system using the one or more connectivity parameters, and then transferring data between the requester system and the target system using the established connection. In transferring the data between the requester system and the target system, the integration system may perform a data transformation process on the transferred data using the one or more transformation parameters of the transformation configuration.

In one or more embodiments, the integration system also uses the procedural interaction configuration in executing the data integration process. In one example, the integration system uses a specific sequence of operations, specified by the procedural interaction configuration, in executing the data integration process. In another example, the integration system uses a set of one or more rules, specified in the procedural interaction configuration, to restrict user input for inclusion in the data to be transferred in the data integration process to a subset of a set of values.

### 4. Example Embodiments

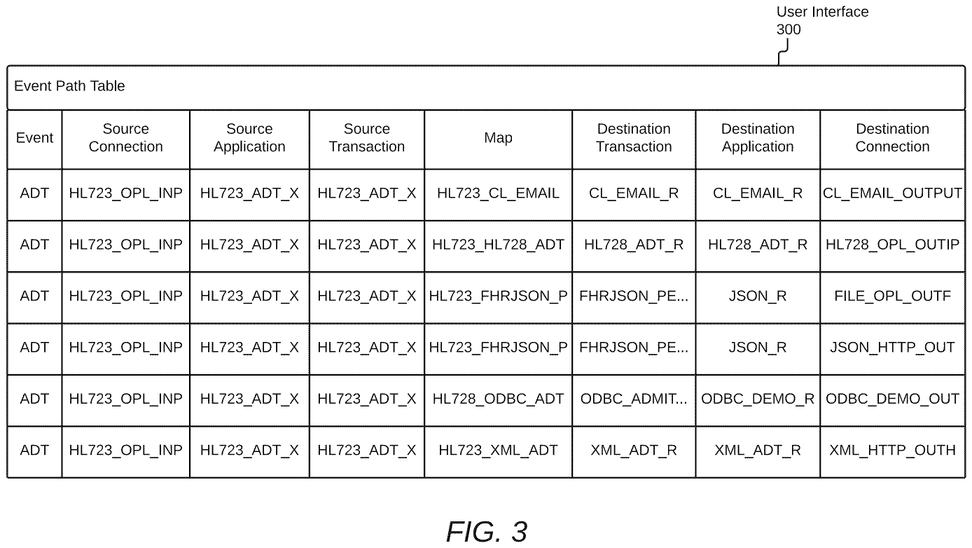

FIG. 3 illustrates a user interface 300 displaying instances of execution of data integration processes between requester systems and target systems in accordance with one or more embodiments. In FIG. 3, the user interface 300 displays a table of events in which rows of the table correspond to instances of execution of data integration processes between requester systems and target systems. An instance of execution may include configuration details of the data integration process that was executed. For example, in FIG. 3, an instance of execution listed in the table includes configurations for a source connection, a source application, a source transaction, a mapping between data fields in a source (e.g., a requester system) and data fields in a destination (e.g., a target system), a destination transaction, a destination application, and a destination connection. The details of the source connection and the destination connection may be used as historical connection parameters for a historical connectivity configuration in training data for training the AI model. The details of the mapping may be used as historical transformation configurations in training data for training the AI model. The details of the source application and the destination application may be used as historical attributes of the requester system and the target system in training data for training the AI model.

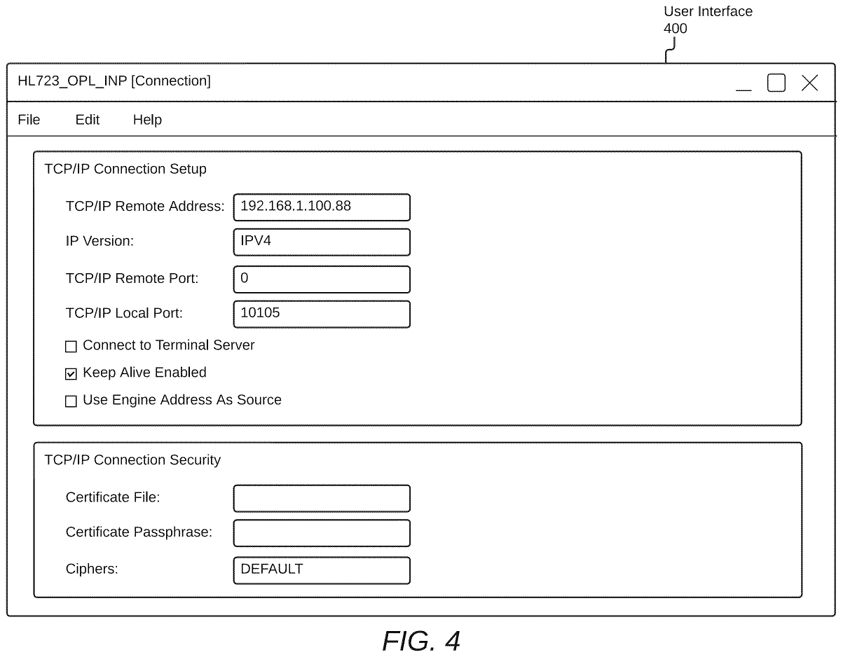

FIG. 4 illustrates a user interface 400 displaying a connectivity configuration in accordance with one or more embodiments. In the example shown in FIG. 4, the connectivity configuration includes values for a TCP/IP remote address, an IP version, a TCP/IP remote port, and a TCP/IP local port. The connectivity configuration may also include values for connection security, such as a certificate file, a certificate passphrase, and a cipher. In one or more embodiments, the AI model may determine the connectivity configuration for the user and autofill connection configuration fields with values based on the determined connectivity configuration. By determining and pre-setting the values that are used to establish a connection between the requester system and the target system, the AI model improves the efficiency of the configuration process. For example, the user does not need to search through old connectivity configuration files to find an appropriate or optimal configuration. Furthermore, the AI model reduces the risk of user error, especially in situations in which the user is not sufficiently knowledgeable about what particular connectivity parameters to use for a particular use case. As a result, the AI model reduces the likelihood of the data integration process suffering a system error or other functional problem due to an incorrect or sub-optimal configuration.

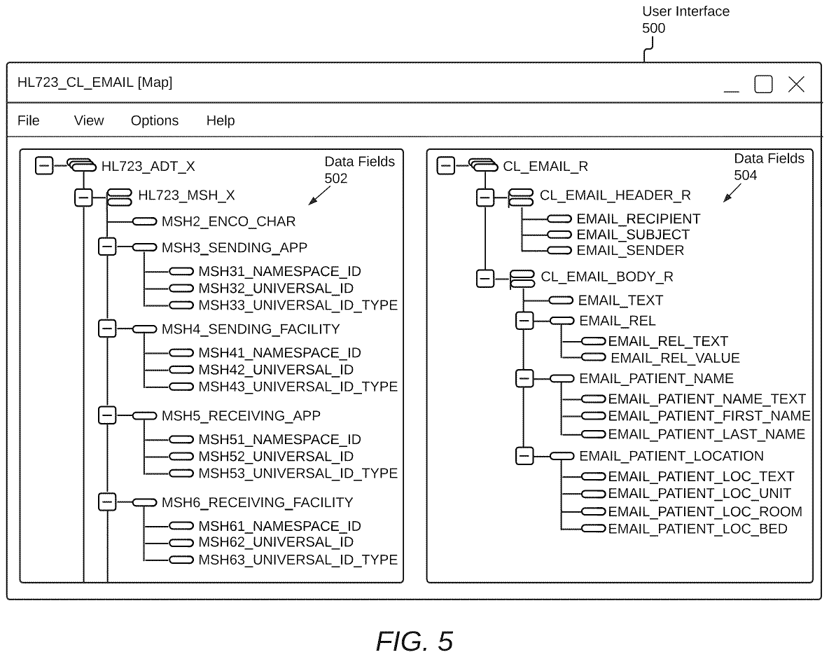

FIG. 5 illustrates a user interface 500 displaying a transformation configuration in accordance with one or more embodiments. In FIG. 5, the transformation configuration includes a mapping between data fields 502 of a requester system and data fields 504 of a target system. In one or more embodiments, the AI model may determine the mapping for the user and present it to the user for use in the data integration process. By determining the mapping to use in the data integration process, the AI model improves the efficiency of the configuration process. For example, the user does not need to search through old transformation configuration files to find or create an appropriate or optimal configuration. Furthermore, the AI model reduces the risk of user error, especially in situations in which the user is not sufficiently knowledgeable about what particular transformation parameters to use for a particular use case. As a result, the AI model reduces the likelihood of the data integration process suffering a system error or other functional problem due to an incorrect or sub-optimal configuration.

### 5. Machine Learning Architecture

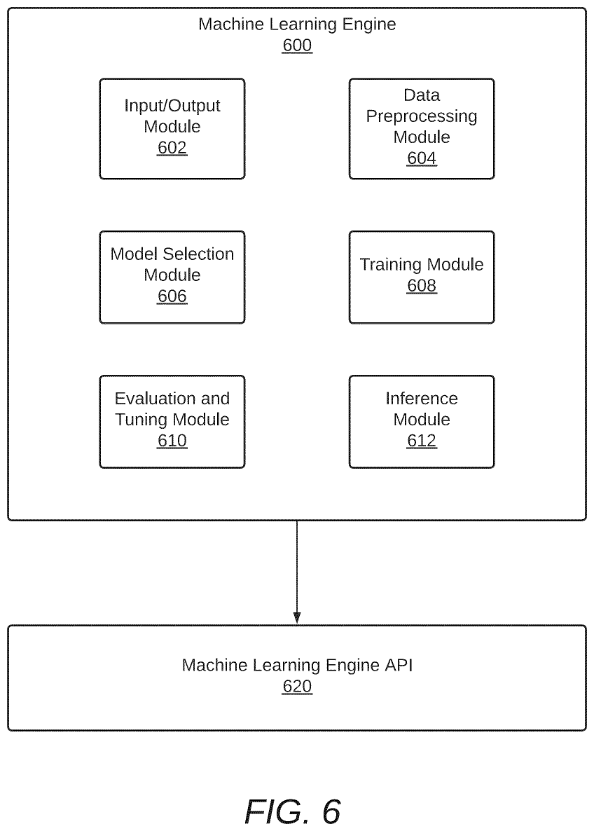

FIG. 6 illustrates a machine learning engine 600 in accordance with one or more embodiments. As illustrated in FIG. 6, machine learning engine 600 includes input/output module 602, data preprocessing module 604, model selection module 606, training module 608, evaluation and tuning module 610, and inference module 612.

In accordance with an embodiment, input/output module 602 serves as the primary interface for data entering and exiting the system, managing the flow and integrity of data. This module may accommodate a wide range of data sources and formats to facilitate integration and communication within the machine learning architecture.

In an embodiment, an input handler within input/output module 602 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 602 to be versatile in different operational contexts, whether processing historical datasets or streaming data.

In accordance with an embodiment, input/output module 602 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 602 includes an output framework designed to handle the distribution and exportation of outputs, predictions, or insights. Using the output framework, input/output module 602 formats these outputs into user-friendly and accessible formats, such as reports, visualizations, or data files compatible with other systems. Input/output module 602 also ensures secure and efficient transmission of these outputs to end-users or other systems in an embodiment and may employ encryption and secure data transfer protocols to maintain data confidentiality.

In accordance with an embodiment, data preprocessing module 604 transforms data into a format suitable for use by other modules in machine learning engine 600. For example, data preprocessing module 604 may transform raw data into a normalized or standardized format suitable for training ML models and for processing new data inputs for inference. In an embodiment, data preprocessing module 604 acts as a bridge between the raw data sources and the analytical capabilities of machine learning engine 600.

In an embodiment, data preprocessing module 604 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 604 may be configured to handle anomalies in different ways depending on context. Data preprocessing module 604 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 604 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 604 processes new data for inference, data preprocessing module 604 replicates the same preprocessing steps to ensure consistency with the training data format. This helps to avoid discrepancies between the training data format and the inference data format, thereby reducing the likelihood of inaccurate or invalid model predictions.

In an embodiment, model selection module 606 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 606 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 606 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 606 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 606 also considers computational efficiency and resource constraints. This is meant to help ensure the selected model is both accurate and practical in terms of computational and time requirements. In an embodiment, certain features of model selection module 606 are configurable such as a configured bias toward (or against) computational efficiency.

In accordance with an embodiment, training module 608 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 608 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 608 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 608 includes logic to handle different types of data and learning tasks. For instance, it includes different training routines for supervised learning (where the training data comes with labels) and unsupervised learning (without labeled data). In the case of deep learning models, training module 608 also manages the complexities of training neural networks that include initializing network weights, choosing activation functions, and setting up neural network layers.

In an embodiment, evaluation and tuning module 610 incorporates dynamic feedback mechanisms and facilitates continuous model evolution to help ensure the system's relevance and accuracy as the data landscape changes. Evaluation and tuning module 610 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 610 performs continuous model tuning by using hyperparameter optimization. Evaluation and tuning module 610 performs an exploration of the hyperparameter space using algorithms, such as grid search, random search, or more sophisticated methods like Bayesian optimization. Evaluation and tuning module 610 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 610 integrates data feedback and updates the model. Evaluation and tuning module 610 actively collects feedback from the model's real-world applications, an indicator of the model's performance in practical scenarios. Such feedback can come from various sources depending on the nature of the application. For example, in a user-centric application like a recommendation system, feedback might include user interactions, preferences, and responses. In other contexts, such as predicting events, it might involve analyzing the model's prediction errors, misclassifications, or other performance metrics in live environments.

In an embodiment, feedback integration logic within evaluation and tuning module 610 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 610 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 612 transforms data raw data into actionable, precise, and contextually relevant predictions. In addition to processing and applying a trained model to new data, inference module 612 may also include post-processing logic that refines the raw outputs of the model into meaningful insights.

In an embodiment, inference module 612 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 612 transforms the outputs of a trained model into definitive classifications. Inference module 612 employs the underlying model as a tool to generate probabilistic outputs for each potential class. It then engages in an interpretative process to convert these probabilities into concrete class labels.

In an embodiment, when inference module 612 receives the probabilistic outputs from the model, it analyzes these probabilities to determine how they are distributed across some or every potential class. If the highest probability is not significantly greater than the others, inference module 612 may determine that there is ambiguity or interpret this as a lack of confidence displayed by the model.

In an embodiment, inference module 612 uses thresholding techniques for applications where making a definitive decision based on the highest probability might not suffice due to the critical nature of the decision. In such cases, inference module 612 assesses if the highest probability surpasses a certain confidence threshold that is predetermined based on the specific requirements of the application. If the probabilities do not meet this threshold, inference module 612 may flag the result as uncertain or defer the decision to a human expert. Inference module 612 dynamically adjusts the decision thresholds based on the sensitivity and specificity requirements of the application, subject to calibration for balancing the trade-offs between false positives and false negatives.

In accordance with an embodiment, inference module 612 contextualizes the probability distribution against the backdrop of the specific application. This involves a comparative analysis, especially in instances where multiple classes have similar probability scores, to deduce the most plausible classification. In an embodiment, inference module 612 may incorporate additional decision-making rules or contextual information to guide this analysis, ensuring that the classification aligns with the practical and contextual nuances of the application.

In regression models, where the outputs are continuous values, inference module 612 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 612 incorporates domain-specific adjustments into its post-processing routine. This involves tailoring the model's output to align with specific industry knowledge or contextual information. For example, in financial forecasting, inference module 612 may adjust predictions based on current market trends, economic indicators, or recent significant events, ensuring that the outputs are both statistically accurate and practically relevant.

In an embodiment, inference module 612 includes logic to handle uncertainty and ambiguity in the model's predictions. In cases where inference module 612 outputs a measure of uncertainty, such as in Bayesian inference models, inference module 612 interprets these uncertainty measures by converting probabilistic distributions or confidence intervals into a format that can be easily understood and acted upon. This provides users with both a prediction and an insight into the confidence level of that prediction. In an embodiment, inference module 612 includes mechanisms for involving human oversight or integrating the instance into a feedback loop for subsequent analysis and model refinement.

In an embodiment, inference module 612 formats the final predictions for end-user consumption. Predictions are converted into visualizations, user-friendly reports, or interactive interfaces. In some systems, like recommendation engines, inference module 612 also integrates feedback mechanisms, where user responses to the predictions are used to continually refine and improve the model, creating a dynamic, self-improving system.

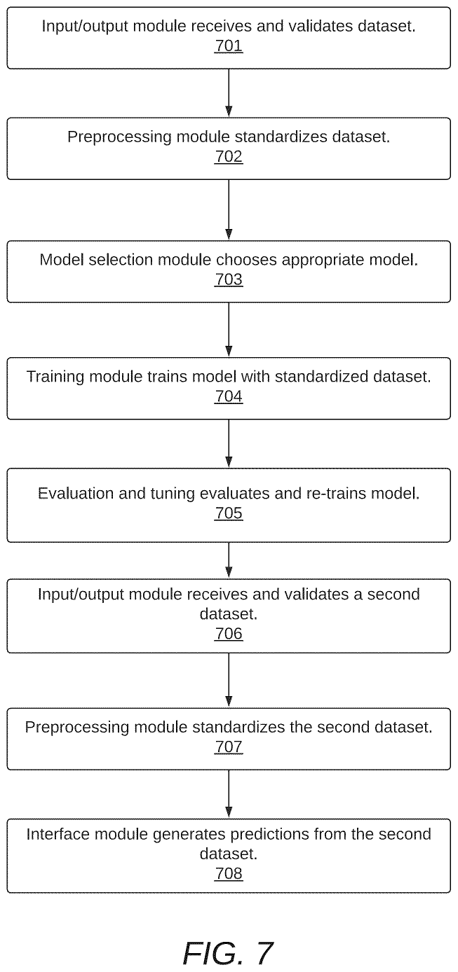

FIG. 7 illustrates the operation of a machine learning engine in one or more embodiments. In an embodiment, input/output module 602 receives a dataset intended for training (Operation 701). This data can originate from diverse sources, like databases or real-time data streams, and in varied formats, such as CSV, JSON, or XML. Input/output module 602 assesses and validates the data, ensuring its integrity by checking for consistency, data ranges, and types.

In an embodiment, training data is passed to data preprocessing module 604. Here, the data undergoes a series of transformations to standardize and clean it, making it suitable for training ML models (Operation 702). This involves normalizing numerical data, encoding categorical variables, and handling missing values through techniques like imputation.

In an embodiment, prepared data from the data preprocessing module 604 is then fed into model selection module 606 (Operation 703). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 608 trains the selected model with the prepared dataset (Operation 704). It implements learning algorithms to adjust the model's internal parameters, optimizing them to identify patterns and relationships in the training data. Training module 608 also addresses the challenge of overfitting by implementing techniques, like regularization and early stopping, ensuring the model's generalizability.

In an embodiment, evaluation and tuning module 610 evaluates the trained model's performance using the validation dataset (Operation 705). Evaluation and tuning module 610 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 602 receives a dataset intended for inference. Input/output module 602 assesses and validates the data (Operation 706).

In an embodiment, data preprocessing module 604 receives the validated dataset intended for inference (Operation 707). Data preprocessing module 604 ensures that the data format used in training is replicated for the new inference data, maintaining consistency and accuracy for the model's predictions.

In an embodiment, inference module 612 processes the new data set intended for inference, using the trained and tuned model (Operation 708). It applies the model to this data, generating raw probabilistic outputs for predictions. Inference module 612 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 620 allows for applications to leverage machine learning engine 600. In an embodiment, machine learning engine API 620 may be built on a RESTful architecture and offer stateless interactions over standard HTTP/HTTPS protocols. Machine learning engine API 620 may feature a variety of endpoints, each tailored to a specific function within machine learning engine 600. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 620 is equipped to support SOAP-based interactions. This extension involves defining a WSDL (Web Services Description Language) document that outlines the API's operations and the structure of request and response messages. In an embodiment, machine learning engine API 620 supports various data formats and communication styles. In an embodiment, machine learning engine API 620 endpoints may handle requests in JSON format or any other suitable format. For example, machine learning engine API 620 may process XML, and it may also be engineered to handle more compact and efficient data formats, such as Protocol Buffers or Avro, for use in bandwidth-limited scenarios.

In an embodiment, machine learning engine API 620 is designed to integrate WebSocket technology for applications necessitating real-time data processing and immediate feedback. This integration enables a continuous, bi-directional communication channel for a dynamic and interactive data exchange between the application and machine learning engine 104.

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a SoftMax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component includes two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 602, when used for large language models, handles textual data, converting input text into a format that the model can process. This typically involves tokenization, where the text is broken down into manageable pieces, such as words or sub words, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 604 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 606, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 608, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 610 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 612, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 6. Practical Applications, Advantages, and Improvements

Embodiments provide several practical applications, advantages, and improvements over existing solutions for determining a configuration of parameters for a data integration process between different systems. In large-scale data integration environments, such as enterprise Extract, Transform, Load (ETL) systems, cloud-based data pipelines, and distributed analytics platforms, configuring data integration processes involves setting hundreds or thousands of parameters (e.g., connection details, transformation rules, schema mappings, resource allocations, and performance tuning options). There are several technical problems that arise due to the complexity of this configuration process and the expert domain knowledge it requires.

One technical problem is that the configuration process is prone to error due to its complexity. Incorrect parameter configuration can result in configuration-related runtime errors, data loss, inconsistency, and inefficient system performance. Furthermore, even if a parameter configuration is error-free, it still may be sub-optimal in terms of its effect on computational efficiency. For example, a parameter configuration that is technically correct can still result in wasteful processing time and excessive system resource consumption if it is not optimized for the specific context for which the data integration process is being requested.

By using an AI model to determine connection and transformation configurations for a data integration process, the integration system disclosed herein prevents configuration-related runtime errors through intelligent, data-driven parameter selection. Additionally, the integration system improves computation efficiency by reducing processing time and system resource consumption through optimization of configuration values in real time. As one example of the practical application of the features disclosed herein, the use of the AI model to determine configurations for data integration processes involving a hospital's computer system significantly improves the functioning of the hospital's computer system. A hospital's computer system regularly executes data integration processes with an everchanging supply of different types of medical dispensing devices (e.g., different brands, different models) and a wide variety of pharmacy software systems. As a result, determining connectivity and transformation configurations that are specifically-tailored for every permutation of system attributes is impractical, inefficient, and error-prone. The integration system disclosed herein enables a novice user of a hospital's computer system (e.g., an EHR system) to easily request a data integration process with any available system without risk of causing system errors that impede the functioning of the hospital's computer system, the target systems, and the data integration processes.

The data input to any ML model and/or the data output from any ML model, as described herein, may be used for operations performed by one or more of the following: Database Software, Cloud Infrastructure Software, Customer Relationship Management Software, Data Science Software, Digital Assistant Software, Vision Software, Language Software, Speech Software, Forecasting Software, Enterprise Software, Middleware, Server Software, Identity Management Software, Application Development Software, Analytics Software, Security Software, Data Integration Software, Health Software, Hospitality Software, Retail Software, Utilities Software, Operating Systems, Virtualization Software, Governance and Administration Software, Migration & Disaster Recovery Software, Networking Software, Connectivity Software, Monitoring Software, Procurement Software, Project Management Software, Risk Management Software, Supply Chain Management Software, Manufacturing Software, Human Capital Management Software, Customer Experience Software, Advertising Software, and Industry-Specific Application Software.

### 7. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network includes a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates application(s) that a tenant(s) is authorized to access. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

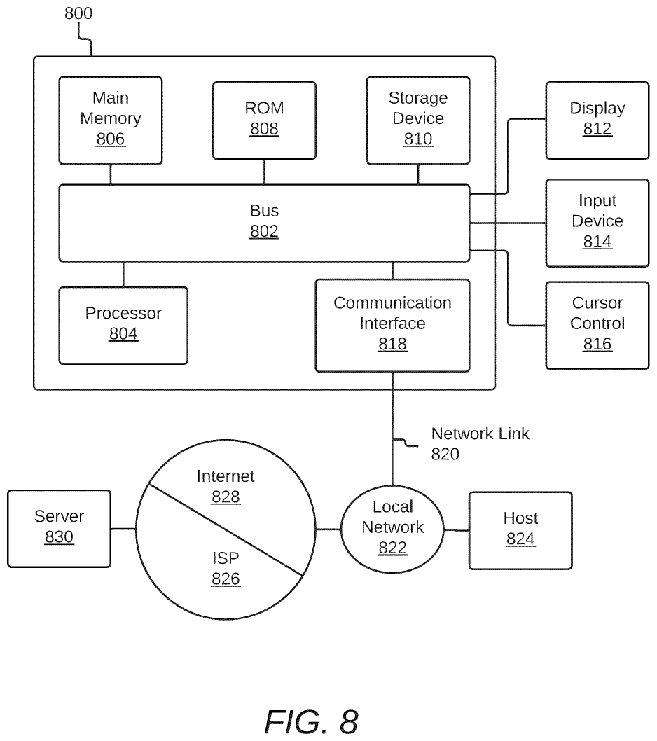

For example, FIG. 8 is a block diagram that illustrates a computer system 800 upon which an embodiment of the disclosure may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read-only memory (ROM) 808 or other static storage device coupled to bus 802 for storing static information and instructions for processor 804. A storage device 810, such as a magnetic disk, optical disk, or a solid-state drive (SSD) is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may include non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, SSD, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that include bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or SSD of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer-readable storage media includes instructions which, when executed by one or more hardware processors, cause performance of any of the operations described herein and/or recited in any of the claims.

In an embodiment, a method includes operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
receiving, from a requester system, a request for a data integration process that transfers data between the requester system and a target system;
obtaining one or more attributes of the requester system and one or more attributes of the target system;
generating, using an artificial intelligence (AI) model, a first connectivity configuration and a first transformation configuration, the AI model generating the first connectivity configuration based on the one or more attributes of the target system, the AI model generating the first transformation configuration based on the one or more attributes of the requester system and the one or more attributes of the target system, the first connectivity configuration comprising one or more connection parameters for establishing a connection between the requester system and the target system, the first transformation configuration comprising one or more transformation parameters for performing a data transformation process; and
executing the data integration process using the first connectivity configuration and the first transformation configuration, the executing of the data integration process comprising:
establishing a connection between the requester system and the target system using the one or more connectivity parameters; and
transferring data between the requester system and the target system using the established connection, the transferring of data comprising performing the data transformation process on the transferred data using the one or more transformation parameters,
wherein the method is performed by at least one device including a hardware processor.

2. The method of claim 1, wherein the generating of the first connectivity configuration comprises:
generating a plurality of connectivity configurations that includes the first connectivity configuration; and
causing the plurality of connectivity configurations to be presented on a computing device,
wherein the first connectivity configuration is used to establish the connection between the requester system and the target system based on a user selection, received via the computing device, of the first connectivity configuration from amongst the plurality of connectivity configurations presented on the computing device.

3. The method of claim 1, wherein the generating of the first transformation configuration comprises:
generating a plurality of transformation configurations that includes the first transformation configuration; and
causing the plurality of transformation configurations to be presented on a computing device,
wherein the first transformation configuration is used to perform the data transformation process on the transferred data based on a user selection, received via the computing device, of the first transformation configuration from amongst the plurality of transformation configurations presented on the computing device.

4. The method of claim 1, further comprising:
training the AI model, using training data, to generate connectivity configurations and transformation configurations, the training data comprising:
historical connectivity configurations used in instances of execution of data integration processes between requester systems and target systems;
historical transformation configurations used in the instances of execution of the data integration processes;
historical attributes of the target systems corresponding to the historical connectivity configurations; and
historical attributes of the requester systems and the target systems corresponding to the historical transformation configurations.

5. The method of claim 1, wherein the one or more connection parameters of the connectivity configuration comprise one or more of a server identification, an Internet Protocol (IP) address, a port identification, a security certificate file, a user identification, a password, a connection type, or a connection protocol.

6. The method of claim 1, wherein the one or more transformation parameters of the transformation configuration comprise one or more data mapping parameters for mapping data between the requester system and the target system.

7. The method of claim 1, wherein the one or more transformation parameters of the transformation configuration comprises one or more data conversion parameters for converting data between a format of the requester system and a format of the target system.

8. The method of claim 1, further comprising:
generating, using the AI model, a procedural interaction configuration based on the one or more attributes of the target system, the procedural interaction configuration comprising: (a) a specific sequence of operations to be used in the execution of the data integration process or (b) a set of one or more rules that restricts user input for inclusion in the data to be transferred between the requester system and the target system in the data integration process to a subset of a set of values; and
executing the data integration process using the procedural interaction configuration.

9. One or more non-transitory computer-readable media storing program instructions that, when executed by one or more hardware processors, cause performance of operations comprising:
receiving, from a requester system, a request for a data integration process that transfers data between the requester system and a target system;
obtaining one or more attributes of the requester system and one or more attributes of the target system;
generating, using an artificial intelligence (AI) model, a first connectivity configuration and a first transformation configuration, the AI model generating the first connectivity configuration based on the one or more attributes of the target system, the AI model generating the first transformation configuration based on the one or more attributes of the requester system and the one or more attributes of the target system, the first connectivity configuration comprising one or more connection parameters for establishing a connection between the requester system and the target system, the first transformation configuration comprising one or more transformation parameters for performing a data transformation process; and
executing the data integration process using the first connectivity configuration and the first transformation configuration, the executing of the data integration process comprising:
establishing a connection between the requester system and the target system using the one or more connectivity parameters; and
transferring data between the requester system and the target system using the established connection, the transferring of data comprising performing the data transformation process on the transferred data using the one or more transformation parameters.

10. The non-transitory computer-readable media of claim 9, wherein the generating of the first connectivity configuration comprises:
generating a plurality of connectivity configurations that includes the first connectivity configuration; and
causing the plurality of connectivity configurations to be presented on a computing device,
wherein the first connectivity configuration is used to establish the connection between the requester system and the target system based on a user selection, received via the computing device, of the first connectivity configuration from amongst the plurality of connectivity configurations presented on the computing device.

11. The non-transitory computer-readable media of claim 9, wherein the generating of the first transformation configuration comprises:
generating a plurality of transformation configurations that includes the first transformation configuration; and
causing the plurality of transformation configurations to be presented on a computing device,
wherein the first transformation configuration is used to perform the data transformation process on the transferred data based on a user selection, received via the computing device, of the first transformation configuration from amongst the plurality of transformation configurations presented on the computing device.

12. The non-transitory computer-readable media of claim 9, wherein the operations further comprise:
training the AI model, using training data, to generate connectivity configurations and transformation configurations, the training data comprising:
historical connectivity configurations used in instances of execution of data integration processes between requester systems and target systems;
historical transformation configurations used in the instances of execution of the data integration processes;
historical attributes of the target systems corresponding to the historical connectivity configurations; and
historical attributes of the requester systems and the target systems corresponding to the historical transformation configurations.

13. The non-transitory computer-readable media of claim 9, wherein the one or more connection parameters of the connectivity configuration comprise one or more of a server identification, an Internet Protocol (IP) address, a port identification, a security certificate file, a user identification, a password, a connection type, or a connection protocol.

14. The non-transitory computer-readable media of claim 9, wherein the one or more transformation parameters of the transformation configuration comprise one or more data mapping parameters for mapping data between the requester system and the target system.

15. The non-transitory computer-readable media of claim 9, wherein the one or more transformation parameters of the transformation configuration comprises one or more data conversion parameters for converting data between a format of the requester system and a format of the target system.

16. The non-transitory computer-readable media of claim 9, further comprising:
generating, using the AI model, a procedural interaction configuration based on the one or more attributes of the target system, the procedural interaction configuration comprising: (a) a specific sequence of operations to be used in the execution of the data integration process or (b) a set of one or more rules that restricts user input for inclusion in the data to be transferred between the requester system and the target system in the data integration process to a subset of a set of values; and
executing the data integration process using the procedural interaction configuration.

17. A system comprising:
one or more hardware processors;
one or more non-transitory computer-readable media; and
program instructions stored on the one or more non-transitory computer-readable media that, when executed by the one or more hardware processors, cause the system to perform operations comprising:
receiving, from a requester system, a request for a data integration process that transfers data between the requester system and a target system;
obtaining one or more attributes of the requester system and one or more attributes of the target system;
generating, using an artificial intelligence (AI) model, a first connectivity configuration and a first transformation configuration, the AI model generating the first connectivity configuration based on the one or more attributes of the target system, the AI model generating the first transformation configuration based on the one or more attributes of the requester system and the one or more attributes of the target system, the first connectivity configuration comprising one or more connection parameters for establishing a connection between the requester system and the target system, the first transformation configuration comprising one or more transformation parameters for performing a data transformation process; and
executing the data integration process using the first connectivity configuration and the first transformation configuration, the executing of the data integration process comprising:
establishing a connection between the requester system and the target system using the one or more connectivity parameters; and
transferring data between the requester system and the target system using the established connection, the transferring of data comprising performing the data transformation process on the transferred data using the one or more transformation parameters.

18. The system of claim 17, wherein the generating of the first connectivity configuration comprises:
generating a plurality of connectivity configurations that includes the first connectivity configuration; and
causing the plurality of connectivity configurations to be presented on a computing device,
wherein the first connectivity configuration is used to establish the connection between the requester system and the target system based on a user selection, received via the computing device, of the first connectivity configuration from amongst the plurality of connectivity configurations presented on the computing device.

19. The system of claim 17, wherein the generating of the first transformation configuration comprises:
generating a plurality of transformation configurations that includes the first transformation configuration; and
causing the plurality of transformation configurations to be presented on a computing device,
wherein the first transformation configuration is used to perform the data transformation process on the transferred data based on a user selection, received via the computing device, of the first transformation configuration from amongst the plurality of transformation configurations presented on the computing device.

20. The system of claim 17, wherein the operations further comprise:
training the AI model, using training data, to generate connectivity configurations and transformation configurations, the training data comprising:
historical connectivity configurations used in instances of execution of data integration processes between requester systems and target systems;
historical transformation configurations used in the instances of execution of the data integration processes;
historical attributes of the target systems corresponding to the historical connectivity configurations; and
historical attributes of the requester systems and the target systems corresponding to the historical transformation configurations.
